(19) United States
(12) Patent Application Publication
(10) Pub. No.: US 2018/0062139 A1
(43) Pub. Date: Mar. 1, 2018

(54) SEPARATOR FOR NONAQUEOUS ELECTROLYTE SECONDARY BATTERY

(71) Applicant: Sumitomo Chemical Company, Limited, Tokyo (JP)

(72) Inventors: Eiko KASHIWAZAKI, Osaka (JP); Chikara MURAKAMI, Osaka (JP)

(21) Appl. No.: 15/689,284

(22) Filed: Aug. 29, 2017

(30) Foreign Application Priority Data
Aug. 31, 2016 (JP) 2016-170103

(51) Int. Cl. H01M 2/16; H01M 10/05

(52) U.S. Cl. CPC H01M 2/16; H01M 10/05

(57) ABSTRACT

A nonaqueous electrolyte secondary battery which includes, as a nonaqueous electrolyte secondary battery separator or as a base material of a nonaqueous electrolyte secondary battery laminated separator, a porous film containing a polyolefin-based resin as a main component and containing phosphoric esters in an amount of not less than 5 ppm and not more than 700 ppm in terms of a mass ratio relative to total mass of the porous film is excellent in rate characteristic maintaining property.

This Nonprovisional application claims priority under 35 U.S.C. §119 on Patent Application No. 2016-170103 filed in Japan on Aug. 31, 2016, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”).

### BACKGROUND ART

Nonaqueous electrolyte secondary batteries, such as lithium ion secondary batteries, have a high energy density and are thus in wide use as batteries for personal computers, mobile telephones, portable information terminals, and the like. Such nonaqueous electrolyte secondary batteries have recently been developed as batteries for vehicles.

As a separator used for a nonaqueous electrolyte secondary battery such as a lithium ion secondary battery, a microporous film containing a polyolefin as a main component has been used (Patent Literature 1).

In recent years, it has been demanded that nonaqueous electrolyte secondary batteries be higher in performance, and nonaqueous electrolyte secondary batteries having a higher rate characteristic maintaining property have been demanded.

### CITATION LIST

### Patent Literature

[Patent Literature 1]

Japanese Patent Application Publication Tokukai No. 2015-120835 (Publication date: Jul. 2, 2015)

### SUMMARY OF INVENTION

### Technical Problem

However, a nonaqueous electrolyte secondary battery including a conventional separator, such as a separator disclosed in Patent Literature 1, has a problem that the nonaqueous electrolyte secondary battery does not have a sufficiently high rate characteristic maintaining property. The rate characteristic maintaining property indicates whether or not a nonaqueous electrolyte secondary battery can withstand a discharge at a large electric current, and is expressed by a ratio of (a) a discharge capacity obtained in a case where the nonaqueous electrolyte secondary battery is discharged at a large electric current to (b) a discharge capacity obtained in a case where the nonaqueous electrolyte secondary battery is discharged at a small electric current. A nonaqueous electrolyte secondary battery which has a low rate characteristic maintaining property is difficult to use in a case where a large electric current is required. In other words, a nonaqueous electrolyte secondary battery which has a higher rate characteristic maintaining property has a higher output characteristic.

### Solution to Problem

As a result of diligent research, the inventors of the present invention found that it is possible to obtain a nonaqueous electrolyte secondary battery separator which can be used to produce a nonaqueous electrolyte secondary battery having a high rate characteristic maintaining property, by adjusting an amount of phosphoric esters to be contained in a polyolefin microporous film serving as the nonaqueous electrolyte secondary battery separator. The inventors of the present invention thus arrived at the present invention.

That is, the present invention can encompass a nonaqueous electrolyte secondary battery separator, a laminated separator for a nonaqueous electrolyte secondary battery (hereinafter referred to as a “nonaqueous electrolyte secondary battery laminated separator”), a member for a nonaqueous electrolyte secondary battery (hereinafter referred to as a “nonaqueous electrolyte secondary battery member”), and a nonaqueous electrolyte secondary battery, each shown below.

[1] A nonaqueous electrolyte secondary battery separator which is a porous film containing a polyolefin-based resin as a main component,

the porous film containing phosphoric esters in an amount of not less than 5 ppm and not more than 700 ppm in terms of a mass ratio relative to total mass of the porous film.

[2] The nonaqueous electrolyte secondary battery separator as set forth in [1], wherein the porous film contains, as the phosphoric esters, at least one compound in an amount of not less than 5 ppm and not more than 700 ppm in terms of a mass ratio relative to total mass of the porous film, the at least one compound being selected from the group consisting of: a compound represented by the following general formula (1); a polymer in which two or more compounds each represented by the general formula (1) are bonded via a single bond(s) or a linking group(s); and a polymer in which one or more compounds, each represented by the general formula (1), and one or more compounds, each represented by a general formula (1′), are bonded via a single bond(s) or a linking group(s),

P(═O)(R¹)(R²)(R³) (1)

where: R¹, R², and R³ each independently represent —OR⁴ or —R⁵; R⁴ and R⁵ each represent a hydrocarbon group and may be each bonded, via a single bond or a linking group, to R⁴ or R⁵ contained in another group in an identical molecule, R⁴ or R⁵ contained in another compound represented by the general formula (1), or R^{4′} or R^{5′} contained in a compound represented by the general formula (1′); and the linking group is a bivalent or higher-valent atom or a bivalent or higher-valent group,

P(R^{1′})(R^{2′})(R^{3′}) (1′)

where: R^{1′}, R^{2′}, and R^{3′} each independently represent —OR^{4′} or —R^{5′}; R^{4′} and R^{5′} each represent a hydrocarbon group and may be each bonded, via a single bond or a linking group, to R^{4′} or R^{5′} contained in another group in an identical molecule, R^{4′} or R^{5′} contained in another compound represented by the general formula (1′), or R⁴ or R⁵ contained in a compound represented by the general formula (1); and the linking group is a bivalent or higher-valent atom or a bivalent or higher-valent group.

[3] The nonaqueous electrolyte secondary battery separator as set forth in [1] or [2], wherein the porous film contains, as the phosphoric esters, at least one compound selected from the group consisting of compounds represented by the following general formulae (2) through (6),

general formula (2):

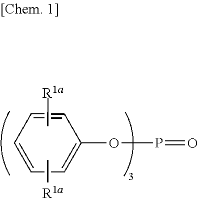

where R^{1a} and R^{2a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group,

general formula (3):

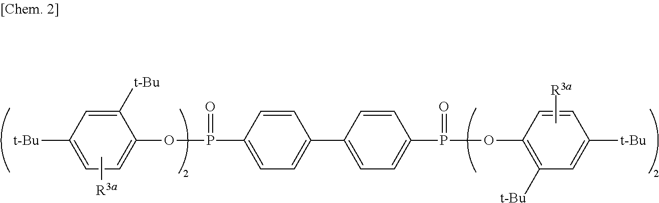

where R^{3a} represents a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group,

general formula (4):

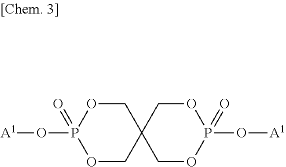

where A¹ represents an alkyl group having 1 to 18 carbon atom(s), a phenyl group which may be substituted with an alkyl group having 1 to 9 carbon atom(s), a phenyl group which may be substituted with a cycloalkyl group having 5 to 8 carbon atoms, a phenyl group which may be substituted with an alkylcycloalkyl group having 6 to 12 carbon atoms, or a phenyl group which may be substituted with an aralkyl group having 7 to 12 carbon atoms,

general formula (5):

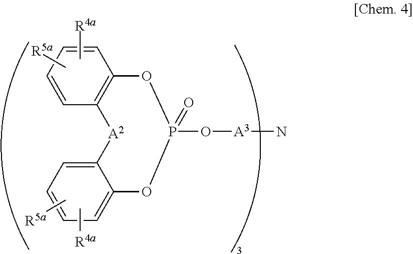

where: R^{4a} and R^{5a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group; A² represents a single bond, a sulfur atom, or an alkylidene group having 1 to 8 carbon atom(s); and A³ represents an alkylene group having 2 to 8 carbon atoms,

general formula (6):

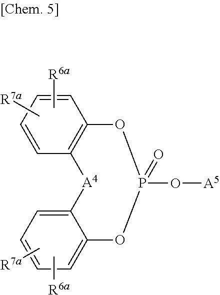

where: R^{6a} and R^{7a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group; A⁴ represents a single bond, a sulfur atom, or an alkylidene group having 1 to 8 carbon atom(s); and A⁵ represents an alkyl group having 1 to 8 carbon atom(s), a phenyl group which may be substituted with an alkyl group having 1 to 9 carbon atom(s), a phenyl group which may be substituted with a cycloalkyl group having 5 to 8 carbon atoms, a phenyl group which may be substituted with an alkylcycloalkyl group having 6 to 12 carbon atoms, or a phenyl group which may be substituted with an aralkyl group having 7 to 12 carbon atoms.

[4] The nonaqueous electrolyte secondary battery separator as set forth in [3], wherein the porous film contains, as the phosphoric esters, a compound represented by the general formula (2) or a compound represented by the general formula (5).

[5] A nonaqueous electrolyte secondary battery laminated separator including: a nonaqueous electrolyte secondary battery separator recited in any one of [1] through [4]; and a porous layer.

[6] A nonaqueous electrolyte secondary battery member including: a cathode; a nonaqueous electrolyte secondary battery separator recited in any one of [1] through [4] or a nonaqueous electrolyte secondary battery laminated separator recited in [5]; and an anode, the cathode, the nonaqueous electrolyte secondary battery separator or the nonaqueous electrolyte secondary battery laminated separator, and the anode being arranged in this order.

[7] A nonaqueous electrolyte secondary battery including a nonaqueous electrolyte secondary battery separator recited in any one of [1] through [4] or a nonaqueous electrolyte secondary battery laminated separator recited in [5].

### Advantageous Effects of Invention

According to an aspect of the present invention, it is possible to provide a nonaqueous electrolyte secondary battery which is excellent in rate characteristic maintaining property, that is, a nonaqueous electrolyte secondary battery which is excellent in output characteristic and which can be therefore sufficiently used even in a case where a large electric current is required.

### DESCRIPTION OF EMBODIMENTS

The following description will discuss, in detail, an embodiment of the present invention. Note that, in this specification, any numerical range expressed as “A to B” means “not less than A and not more than B.”

### Embodiment 1: Nonaqueous Electrolyte Secondary Battery Separator, Embodiment 2: Nonaqueous Electrolyte Secondary Battery Laminated Separator

A nonaqueous electrolyte secondary battery separator in accordance with Embodiment 1 of the present invention is a nonaqueous electrolyte secondary battery separator which is a porous film containing a polyolefin-based resin as a main component, the porous film containing phosphoric esters in an amount of not less than 5 ppm and not more than 700 ppm in terms of a mass ratio relative to total mass of the porous film.

The phosphoric esters encompass any phosphoric esters and any polymers in each of which two or more monomers are bonded via a single bond(s) or a linking group(s) and at least one of the two or more monomers is any phosphoric ester.

Examples of the phosphoric esters encompass: a compound represented by the following general formula (1); a polymer in which two or more compounds each represented by the general formula (1) are bonded via a single bond(s) or a linking group(s); and a polymer in which one or more compounds, each represented by the general formula (1), and one or more compounds, each represented by a general formula (1′), are bonded via a single bond(s) or a linking group(s).

P(═O)(R¹)(R²)(R³) (1)

where: R¹, R², and R³ each independently represent —OR⁴ or —R⁵; R⁴ and R⁵ each represent a hydrocarbon group and may be each bonded, via a single bond or a linking group, to R⁴ or R⁵ contained in another group in an identical molecule, R⁴ or R⁵ contained in another compound represented by the general formula (1), or R^{4′} or R^{5′} contained in a compound represented by the general formula (1′); and the linking group is a bivalent or higher-valent atom or a bivalent or higher-valent group.

P(R^{1′})(R^{2′})(R^{3′}) (1′)

where: R^{1′}, R^{2′}, and R^{3′} each independently represent —OR^{4′} or —R^{5′}; R^{4′} and R^{5′} each represent a hydrocarbon group and may be each bonded, via a single bond or a linking group, to R^{4′} or R^{5′} contained in another group in an identical molecule, R^{4′} or R^{5′} contained in another compound represented by the general formula (1′), or R⁴ or R⁵ contained in a compound represented by the general formula (1); and the linking group is a bivalent or higher-valent atom or a bivalent or higher-valent group.

Note that, in this specification, the term “polymer” means a compound in which two or more compounds each of which is a monomer are bonded via a single bond(s) or a linking group(s). Note also that, in this specification, a linking group encompasses both of a bivalent or higher-valent atom and a bivalent or higher-valent group.

A nonaqueous electrolyte secondary battery laminated separator in accordance with Embodiment 2 of the present invention includes the nonaqueous electrolyte secondary battery separator (porous film) in accordance with Embodiment 1 of the present invention and a porous layer. Specifically, the nonaqueous electrolyte secondary battery laminated separator in accordance with Embodiment 2 of the present invention is arranged such that the porous layer is provided on at least one of surfaces of the nonaqueous electrolyte secondary battery separator in accordance with Embodiment 1 of the present invention.

A porous film in accordance with an embodiment of the present invention can serve as the nonaqueous electrolyte secondary battery separator or can alternatively serve as a base material of the nonaqueous electrolyte secondary battery laminated separator (later described). The porous film contains a polyolefin-based resin as a main component, and has therein many pores, connected to one another, so that a gas and a liquid can pass through the porous film from one side thereof to the other side thereof. The porous film can be made of a single layer or can be alternatively made of a plurality of layers provided on one another.

Note that the phrase “the porous film contains a polyolefin-based resin as a main component” means that the porous film contains the polyolefin-based resin in an amount of not less than 50% by volume, preferably not less than 90% by volume, more preferably not less than 95% by volume, relative to the whole porous film. The polyolefin-based resin more preferably contains a high molecular weight component having a weight average molecular weight of 3×10⁵ to 15×10⁶. In particular, the polyolefin-based resin more preferably contains a high molecular weight component having a weight average molecular weight of not less than 1,000,000, because this allows an increase in strength of the nonaqueous electrolyte secondary battery separator, that is, the porous film and in strength of the nonaqueous electrolyte secondary battery laminated separator which is a laminated body including the porous film.

The polyolefin-based resin which is a main component of the porous film is not limited to any particular one. Examples of the polyolefin-based resin encompass homopolymers (such as polyethylene, polypropylene, and polybutene) and copolymers (such as an ethylene-propylene copolymer) each of which homopolymers and copolymers is a thermoplastic resin and is produced through (co)polymerization of a monomer(s) such as ethylene, propylene, 1-butene, 4-methyl-1-pentene, and/or 1-hexene. Out of those polymers, polyethylene is more preferable because it is possible to prevent (shut down), at a lower temperature, a flow of an excessively large electric current. Examples of the polyethylene encompass low-density polyethylene, high-density polyethylene, linear polyethylene (ethylene-α-olefin copolymer), and ultra-high molecular weight polyethylene having a weight average molecular weight of not less than 1,000,000. In particular, high molecular weight polyethylene having a weight average molecular weight of 300,000 to 1,000,000 or ultra-high molecular weight polyethylene having a weight average molecular weight of not less than 1,000,000 is still more preferable. Concrete examples of the polyolefin-based resin encompass a polyolefin-based resin which is made of a mixture of (i) a polyolefin having a weight average molecular weight of not less than 1,000,000 and (ii) a low molecular weight polyolefin having a weight average molecular weight of less than 10,000.

In a case where the porous film serves as the nonaqueous electrolyte secondary battery separator by itself, a film thickness of the porous film is preferably 4 μm to 40 μm, more preferably 5 μm to 30 μm, still more preferably 6 μm to 15 μm. In a case where the porous film is used as a base material and the porous layer is provided on one or each of surfaces of the porous film so as to produce the nonaqueous electrolyte secondary battery laminated separator (laminated body), the film thickness of the porous film can be determined as appropriate in consideration of a film thickness of the laminated body. The film thickness of the porous film is preferably 4 μm to 40 μm, more preferably 5 μm to 20 μm.

The film thickness of the porous film is preferably not less than 4 μm because such a porous film makes it possible to sufficiently prevent, in a nonaqueous electrolyte secondary battery which includes the nonaqueous electrolyte secondary battery separator, that is, the porous film or the nonaqueous electrolyte secondary battery laminated separator including the porous film, an internal short circuit caused by breakage or the like of the nonaqueous electrolyte secondary battery. Meanwhile, the film thickness of the porous film is preferably not more than 40 μm because such a porous film makes it possible to (i) suppress an increase in resistance, to permeation of lithium ions, of the entire nonaqueous electrolyte secondary battery separator, that is, the porous film or the entire nonaqueous electrolyte secondary battery laminated separator including the porous film, (ii) prevent, in the nonaqueous electrolyte secondary battery which includes the nonaqueous electrolyte secondary battery separator or the nonaqueous electrolyte secondary battery laminated separator, a deterioration in cathode, rate characteristic, and/or cycle characteristic which deterioration is caused in a case where charge-discharge cycles are repeated, and (iii) prevent an increase in size of the nonaqueous electrolyte secondary battery itself which increase is caused by an increase in distance between a cathode and an anode.

A weight per unit area of the porous film can be determined as appropriate in consideration of strength, a film thickness, mass, and handleability of the nonaqueous electrolyte secondary battery separator, that is, the porous film or the nonaqueous electrolyte secondary battery laminated separator including the porous film. Specifically, in general, the weight per unit area of the porous film is preferably 4 g/m² to 20 g/m², more preferably 5 g/m² to 12 g/m² so that the nonaqueous electrolyte secondary battery, which includes the nonaqueous electrolyte secondary battery separator or the nonaqueous electrolyte secondary battery laminated separator, has a higher weight energy density and a higher volume energy density.

Air permeability of the porous film is preferably, in terms of Gurley values, 30 sec/100 mL to 500 sec/100 mL, more preferably 50 sec/100 mL to 300 sec/100 mL. In a case where the porous film has the above air permeability, the nonaqueous electrolyte secondary battery separator, that is, the porous film or the nonaqueous electrolyte secondary battery laminated separator including the porous film can achieve sufficient ion permeability.

A porosity of the porous film is preferably 20% by volume to 80% by volume, more preferably 30% by volume to 75% by volume so that the porous film can (i) retain an increased amount of an electrolyte and (ii) obtain a function of surely preventing (shutting down), at a lower temperature, a flow of an excessively large electric current. The porosity of the porous film is preferably not less than 20% by volume in that it is possible to suppress resistance of the porous film. Furthermore, the porosity of the porous film is preferably not more than 80% by volume in view of mechanical strength of the porous film.

A pore diameter of each of the pores in the porous film is preferably not more than 0.3 μm, more preferably not more than 0.14 μm so that the nonaqueous electrolyte secondary battery separator, that is, the porous film or the nonaqueous electrolyte secondary battery laminated separator including the porous film can (i) achieve sufficient ion permeability and (ii) prevent particles from entering the cathode and the anode.

The porous film in accordance with an embodiment of the present invention can contain, as phosphoric esters, at least one compound (polymer) selected from the group consisting of: a compound represented by the following general formula (1); a polymer in which two or more compounds each represented by the general formula (1) are bonded via a single bond(s) or a linking group(s); and a polymer in which one or more compounds, each represented by the general formula (1), and one or more compounds, each represented by the general formula (1′), are bonded via a single bond(s) or a linking group(s).

P(═O)(R¹)(R²)(R³) (1)

where: R¹, R², and R³ each independently represent —OR⁴ or —R⁵; and R⁴ and R⁵ each represent a hydrocarbon group.

P(R^{1′})(R^{2′})(R^{3′}) (1′)

where: R^{1′}, R^{2′}, and R^{3′} each independently represent —OR^{4′} or —R^{5′}; R^{4′} and R^{5′} each represent a hydrocarbon group; and R^{1′} through R^{5′} may be identical to or different from R¹ through R⁵, respectively, in the general formula (1).

Note that, as the phosphoric esters, merely one kind of compound (polymer) can be contained or a mixture of two or more kinds of compounds (polymers) can be alternatively contained.

Note also that R⁴ and R⁵ may be each bonded, via a single bond or a linking group, to R⁴ or R⁵ contained in another group in an identical molecule, R⁴ or R⁵ contained in another compound represented by the general formula (1), or R^{4′} or R^{5′} contained in a compound represented by the general formula (1′). In other words, the compound represented by the general formula (1) can form (i) a ring structure by R⁴ and R⁵ contained in the compound being each bonded, via a single bond or a linking group, to R⁴ or R⁵ contained in another group in an identical molecule, (ii) a polymer in which two or more compounds each represented by the general formula (1) are bonded, by R⁴ and R⁵ contained in the compound being each bonded, via a single bond or a linking group, to R⁴ or R⁵ contained in another compound represented by the general formula (1), or (iii) a polymer in which one or more compounds, each represented by the general formula (1), and one or more compounds, each represented by the general formula (1′), are bonded via a single bond(s) or a linking group(s), by R⁴ and R⁵ contained in the compound being each bonded, via a single bond or a linking group, to R^{4′} or R^{5′} contained in a compound represented by the general formula (1′). Examples of those polymers encompass: dimers such as a compound represented by a general formula (3) (later described) and a compound represented by a general formula (4) (later described); and trimers such as a compound (polymer) represented by a general formula (5).

Note that the polymer in which one or more compounds, each represented by the general formula (1), and one or more compounds, each represented by the general formula (1′), are bonded via a single bond(s) or a linking group(s) only needs to contain one or more moieties each derived from the compound represented by the general formula (1).

In a case where the above-described polymer containing more than one phosphorus (P) is contained as the phosphoric esters in accordance with an embodiment of the present invention, a polymer obtained from compounds each represented by the general formula (1) is preferably contained as the phosphoric esters.

The linking group is not limited to any particular one. Examples of the linking group encompass bivalent atoms, trivalent atoms, bivalent groups, and trivalent groups. Concrete examples of the linking group encompass heteroatoms and alkylidene groups. Out of the heteroatoms, a nitrogen atom or a sulfur atom is preferable. Out of the alkylidene groups, an alkylidene group having 1 to 8 carbon atom(s) is preferable.

R⁴, R⁵, R^{4′}, and R^{5′} are each not limited to any particular one. Examples of each of R⁴, R⁵, R^{4′}, and R^{5′} encompass alkyl groups, alkylene groups, unsubstituted phenyl groups, and substituted phenyl groups. Out of the alkyl groups, an alkyl group having 1 to 18 carbon atom(s) is preferable, and an alkyl group having 1 to 8 carbon atom(s) is more preferable. An alkylene group having 2 to 8 carbon atoms is preferable.

A substituent of each of the substituted phenyl groups is not limited to any particular one. Examples of the substituent encompass alkyl groups, cycloalkyl groups, alkylcycloalkyl groups, aralkyl groups, and phenyl groups. The substituent is preferably an alkyl group having 1 to 9 carbon atom(s), a cycloalkyl group having 5 to 8 carbon atoms, an alkylcycloalkyl group having 6 to 12 carbon atoms, or an aralkyl group having 2 to 8 carbon atoms.

As the phosphoric esters, a compound represented by any one of the following general formulae (2) through (6) is preferable, and a compound represented by the general formula (2) or a compound represented by the general formula (5) is more preferable.

### General Formula (2):

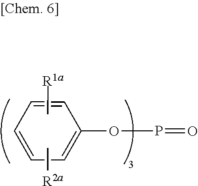

where R^{1a} and R^{2a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group.

### General Formula (3):

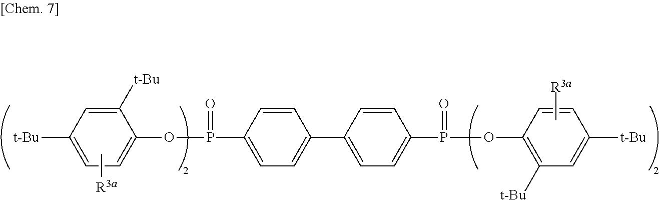

where R^{3a} represents a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group.

### General Formula (4):

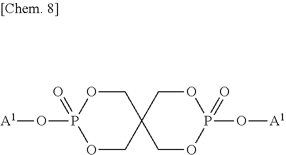

where A¹ represents an alkyl group having 1 to 18 carbon atom(s), a phenyl group which may be substituted with an alkyl group having 1 to 9 carbon atom(s), a phenyl group which may be substituted with a cycloalkyl group having 5 to 8 carbon atoms, a phenyl group which may be substituted with an alkylcycloalkyl group having 6 to 12 carbon atoms, or a phenyl group which may be substituted with an aralkyl group having 7 to 12 carbon atoms.

### General Formula (5):

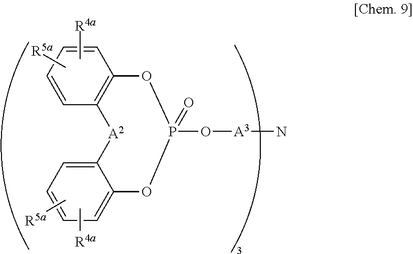

where: R^{4a} and R^{5a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group; A² represents a single bond, a sulfur atom, or an alkylidene group having 1 to 8 carbon atom(s); and A³ represents an alkylene group having 2 to 8 carbon atoms.

### General Formula (6):

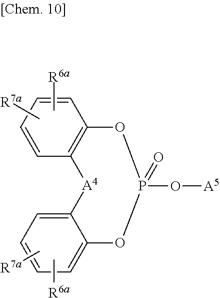

where: R^{6a} and R^{7a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group; A⁴ represents a single bond, a sulfur atom, or an alkylidene group having 1 to 8 carbon atom(s); and A⁵ represents an alkyl group having 1 to 8 carbon atom(s), a phenyl group which may be substituted with an alkyl group having 1 to 9 carbon atom(s), a phenyl group which may be substituted with a cycloalkyl group having 5 to 8 carbon atoms, a phenyl group which may be substituted with an alkylcycloalkyl group having 6 to 12 carbon atoms, or a phenyl group which may be substituted with an aralkyl group having 7 to 12 carbon atoms.

The phosphoric esters in accordance with an embodiment of the present invention have a molecular weight of preferably 100 to 5,000, more preferably 500 to 2,000. The phosphoric esters which have a molecular weight falling within the above range make it possible to (i) suitably adjust a concentration of phosphorus (P) contained in the porous film and, as a result, (ii) suitably improve a rate characteristic maintaining property of the nonaqueous electrolyte secondary battery which includes a resultant nonaqueous electrolyte secondary battery separator.

Concrete examples of the phosphoric esters in accordance with an embodiment of the present invention encompass tris(2,4-di-tert-butylphenyl)phosphate and Phenol, 2-(1,1-dimethylethyl)-6-methyl-4-[3-[[2,4,8,10-tetrakis(1,1-dimethylethyl)-6-oxidodibenzo[d,f][1,3,2]dioxaphosphepin-6-yl]oxy]propyl].

The phosphoric esters are contained in an amount of 5 ppm to 700 ppm, preferably 5 ppm to 400 ppm, more preferably 5 ppm to 300 ppm, in terms of a mass ratio relative to total mass of the porous film. The porous film which contains the phosphoric esters in an amount falling within the above range makes it possible to improve the rate characteristic maintaining property of the nonaqueous electrolyte secondary battery which includes the nonaqueous electrolyte secondary battery separator in accordance with an embodiment of the present invention or the nonaqueous electrolyte secondary battery laminated separator in accordance with an embodiment of the present invention.

As a reason why the rate characteristic maintaining property is improved, the following is considered. That is, phosphoric esters coordinate with an Li cation which is an electrolyte, and form a complex together with an electrolyte anion (for example, PF₆⁻). This causes stabilization of an electrolyte salt (for example, an improvement in hydrolysis resistance), and accordingly suppresses generation of an electrolyte-insoluble component, such as an LiF salt, which is generated as a by-product during charge-discharge cycles and which causes a deterioration in rate characteristic. As a result, the rate characteristic is maintained even after the charge-discharge cycles. Note that, in a case where an amount of the phosphoric esters is too large, the phosphoric esters excessively coordinate with an Li cation, and a desolvation process is accordingly prevented, so that the rate characteristic is rather deteriorated.

The porous film in accordance with an embodiment of the present invention can have thereon a publicly known porous layer such as an adhesive layer, a heat-resistant layer, and/or a protective layer. In this specification, a separator including the nonaqueous electrolyte secondary battery separator and such a porous layer is referred to as a nonaqueous electrolyte secondary battery laminated separator (hereinafter also referred to as a laminated separator).

[Method of Producing Porous Film]

A method of producing the porous film is not limited to any particular one and can be, for example, a method in which a pore forming agent is added to a resin such as a polyolefin, the resin thus obtained is formed into a film (filmy shape), and then the pore forming agent is removed by use of an appropriate solvent.

Specifically, for example, in a case where the porous film is produced with use of a polyolefin resin containing ultra-high molecular weight polyethylene and a low molecular weight polyolefin which has a weight-average molecular weight of not more than 10,000, it is preferable to, from the viewpoint of production costs, produce the porous film by a method including the following steps:

(1) obtaining a polyolefin resin composition by kneading 100 parts by mass of ultra-high molecular weight polyethylene, 5 parts by mass to 200 parts by mass of a low molecular weight polyolefin having a weight-average molecular weight of not more than 10,000, and 100 parts by mass to 400 parts by mass of a pore forming agent;
(2) forming a rolled sheet by rolling the polyolefin resin composition;
(3) removing the pore forming agent from the rolled sheet obtained in the step (2);
(4) stretching a resultant sheet from which the pore forming agent has been removed in the step (3); and
(5) obtaining a porous film by carrying out, with respect to the sheet which has been stretched in the step (4), heat fixation at a heat fixation temperature of not less than 100° C. and not more than 150° C.

Alternatively, instead of the steps (3) through (5), the method includes:

(3′) stretching the rolled sheet which has been obtained in the step (2);
(4′) removing the pore forming agent from a resultant sheet which has been stretched in the step (3′); and
(5′) obtaining a porous film by carrying out, with respect to the sheet which has been obtained in the step (4′), heat fixation at a heat fixation temperature of not less than 100° C. and not more than 150° C.

Examples of the pore forming agent encompass an inorganic filler and a plasticizer.

The inorganic filler is not limited to any particular one. Examples of the inorganic filler encompass an inorganic filler which can be dissolved in a water-based solvent containing an acid, an inorganic filler which can be dissolved in a water-based solvent containing an alkali, and an inorganic filler which can be dissolved in a water-based solvent mainly composed of water. Examples of the inorganic filler which can be dissolved in a water-based solvent containing an acid encompass calcium carbonate, magnesium carbonate, barium carbonate, zinc oxide, calcium oxide, aluminum hydroxide, magnesium hydroxide, calcium hydroxide, and calcium sulfate. Calcium carbonate is preferable because fine powder is easily obtained at a low cost. Examples of the inorganic filler which can be dissolved in a water-based solvent containing an alkali encompass silicic acid and zinc oxide. Silicic acid is preferable because fine powder is easily obtained at a low cost. Examples of the inorganic filler which can be dissolved in a water-based solvent mainly composed of water encompass calcium chloride, sodium chloride, and magnesium sulfate.

The plasticizer is not limited to any particular one. Examples of the plasticizer encompass low molecular weight hydrocarbons such as liquid paraffin.

A weight-average molecular weight of whole polymers constituting the resin used to produce the porous film is preferably not more than 1,000,000, more preferably not more than 800,000 in a resin composition obtained in the step (1). The weight-average molecular weight is preferably not more than 1,000,000 in that the polymers are less entangled with each other in the porous film and, accordingly, the porous film is more easily stretched (i.e., more easily creeps). Moreover, such resin polymers constituting the porous film can be of a linear chain type or a branched chain type, but is preferably of a linear chain type in view of a reduction in entanglement of the polymers.

A melt flow rate (MFR) of the resin composition obtained in the step (1) is preferably not less than 20 g/10 min, more preferably not less than 30 g/10 min, and still more preferably not less than 32 g/10 min. Moreover, the melt flow rate is preferably not more than 50 g/10 min.

The melt flow rate is measured by the following method:

Measurement standard: JIS K 7120-1
Measurement conditions:

Orifice: diameter of 3 mm×length of 10 mm

Measurement temperature: 240° C.

Load: 21.6 kg.

The porosity of the porous film to be obtained can be adjusted, for example, by adjusting a used amount of the pore forming agent. The used amount of the pore forming agent is preferably 100 parts by mass to 300 parts by mass, more preferably 100 parts by mass to 200 parts by mass, relative to 100 parts by mass of the resin contained in the porous film.

Furthermore, the heat fixation temperature in the step (5) is preferably not less than 100° C. and not more than 140° C., more preferably not less than 105° C. and not more than 120° C. In a case where the heat fixation temperature is higher than 140° C., the pores in the porous film are likely to be squashed and blocked.

[Method of Adjusting Amount of Phosphoric Esters]

The porous film in accordance with an embodiment of the present invention contains the phosphoric esters in an amount of 5 ppm to 700 ppm in terms of a mass ratio relative to total mass of the porous film. A method of adjusting the amount of the phosphoric esters is not limited to any particular one. Examples of the method encompass the following methods (i) through (iii):

(i) a method in which the porous film produced by the above-described production method is impregnated with a phosphoric esters solution and then a solvent contained in the phosphoric esters solution is removed;
(ii) a method in which the phosphoric esters are added while the porous film is being produced by the above-described production method; and
(iii) a method in which the amount of the phosphoric esters is adjusted by cleaning, with use of a solvent, the porous film which contains the phosphoric esters.

Note that merely one of those methods can be employed or some of those methods can be alternatively employed in combination.

In the method (i), the solvent contained in the phosphoric esters solution is not limited to any particular one, provided that the solvent dissolves the phosphoric esters and does not dissolve the porous film. Examples of the solvent encompass acetone, chloroform, N-methyl-2-pyrrolidone. Note that the solvent can be merely one kind of solvent or can be alternatively a mixture of two or more kinds of solvents.

In the method (i), a concentration of the phosphoric esters solution, an impregnation time during which the porous film is impregnated with the phosphoric esters solution, an impregnation temperature at which the porous film is impregnated with the phosphoric esters solution, and the like can be determined as appropriate in accordance with an intended amount of the phosphoric esters to be contained in the porous film. Specifically, for example, the concentration of the phosphoric esters solution is preferably 1.0×10⁻⁷ mol/L to 1.0×10⁻¹ mol/L. The impregnation time is preferably 10 seconds to 5 minutes. The impregnation temperature is preferably 15° C. to 30° C.

In the method (i), a method of removing the solvent is not limited to any particular one. For example, the solvent can be removed by evaporating the solvent. Examples of a method of removing the solvent by evaporating the solvent encompass a method in which the porous film which has been impregnated with the phosphoric esters solution is dried by natural drying, air-blowing drying, heat drying, drying under reduced pressure, or the like. Note that, in a case where the porous film is dried by heating the porous film, it is desirable to dry the porous film at a temperature at which the air permeability of the porous film is not decreased, i.e., at a temperature of 10° C. to 80° C., preferably 20° C. to 40° C. so that it is avoided that the pores in the porous film are shrunk and the air permeability of the porous film is accordingly decreased. Note also that a typical drying device can be used to dry the porous film.

In the method (ii), the phosphoric esters can be added in any of the steps of the method of producing the porous film. It is preferable to add the phosphoric esters to the polyolefin resin composition, which is a raw material, before the step (2) of forming the rolled sheet.

An added amount of the phosphoric esters can be determined as appropriate in accordance with an intended amount of the phosphoric esters to be contained in the porous film.

In the method (iii), the porous film which contains the phosphoric esters is not limited to any particular one, and can be a porous film produced from the polyolefin resin composition containing a phosphorous antioxidant, a porous film obtained by the method (i), or a porous film obtained by the method (ii).

In the method (iii), the solvent used to clean the porous film is not limited to any particular one, provided that the solvent does not dissolve the porous film but dissolves the phosphoric esters. Examples of the solvent encompass aprotic solvents. Examples of the aprotic solvents encompass N-methyl-2-pyrrolidone (NMP), N,N-dimethylacetamide, and diethyl carbonate. Note that the solvent can be merely one kind of solvent or can be alternatively a mixture of two or more kinds of solvents.

In the method (iii), conditions under which the porous film is cleaned, such as a cleaning time during which the porous film is cleaned and a cleaning temperature at which the porous film is cleaned, can be determined as appropriate in accordance with an intended amount of the phosphoric esters to be contained in the porous film. Specifically, for example, the cleaning time is preferably 1 minute to 100 hours. The cleaning temperature is preferably 20° C. to 80° C.

[Method of Measuring Amount of Phosphoric Esters]

The amount of the phosphoric esters contained in the porous film in accordance with an embodiment of the present invention can be measured as follows. That is, the porous film is subjected to Soxhlet extraction, while chloroform is being heated and refluxed, so that an extraction liquid is obtained. The extraction liquid thus obtained is subjected to liquid chromatography, and the amount of the phosphoric esters contained in the extraction liquid is quantified. An amount of the porous film subjected to the Soxhlet extraction can be set as appropriate, and, for example, 3 g. Furthermore, an extraction time during which the porous film is subjected to the Soxhlet extraction, that is, a time period during which chloroform is heated and refluxed can be set as appropriate. For example, the extraction time can be 8 hours.

[Porous Layer]

The porous layer in accordance with an embodiment of the present invention can contain fine particles, and is typically a resin layer containing a resin. The porous layer in accordance with an embodiment of the present invention is preferably a heat-resistant layer or an adhesive layer each of which is provided on one or each of the surfaces of the porous film. The resin constituting the porous layer is preferably insoluble in an electrolyte of a battery and is preferably electrochemically stable in a range of use of the battery. In a case where the porous layer is provided on one of the surfaces of the porous film, the porous layer is preferably provided on a surface of the porous film which surface faces the cathode in the nonaqueous electrolyte secondary battery, and is more preferably provided on the surface so as to be in contact with the cathode.

Concrete examples of the resin encompass: polyolefins such as polyethylene, polypropylene, polybutene, and an ethylene-propylene copolymer; fluorine-containing resins such as a homopolymer of vinylidene fluoride (polyvinylidene fluoride), copolymers of vinylidene fluoride (e.g., a vinylidene fluoride-hexafluoropropylene copolymer and a vinylidene fluoride-hexafluoropropylene-tetrafluoroethylene copolymer), copolymers of tetrafluoroethylene (e.g., an ethylene-tetrafluoroethylene copolymer); fluorine-containing rubbers each having a glass transition temperature of not more than 23° C., out of the fluorine-containing resins; aromatic polyamides; wholly aromatic polyamides (aramid resins); rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins each having a melting point or a glass transition temperature of not less than 180° C., such as polyphenylene ether, polysulfone, polyether sulfone, polyphenylene sulfide, polyetherimide, polyamide imide, polyetheramide, and polyester; and water-soluble polymers such as polyvinyl alcohol, polyethylene glycol, cellulose ether, sodium alginate, polyacrylic acid, polyacrylamide, and polymethacrylic acid.

As the resin contained in the porous layer in accordance with an embodiment of the present invention, a water-insoluble polymer can be also suitably used. In other words, it is also preferable to produce the porous layer in accordance with an embodiment of the present invention which porous layer contains a water-insoluble polymer (e.g., an acrylate-based resin) as the resin, with use of an emulsion obtained by dispersing the water-insoluble polymer in an aqueous solvent.

Note, here, that the water-insoluble polymer is a polymer which is not dissolved in an aqueous solvent but is dispersed in the aqueous solvent in the form of particles. A definition of the water-insoluble polymer is not clear. However, according to, for example, International Publication No. 2013/031690, it is defined that the phrase “a polymer is water-insoluble” means that, in a case where 0.5 g of a polymer is dissolved in 100 g of water at a temperature of 25° C., not less than 90% by weight of the polymer remains undissolved in the water. On the other hand, it is defined that the phrase “a polymer is water-soluble” means that, in a case where 0.5 g of a polymer is dissolved in 100 g of water at a temperature of 25° C., less than 0.5% by weight of the polymer remains undissolved in the water. A shape of each of the particles of the water-insoluble polymer is not limited to any particular one, but is preferably a spherical shape.

The water-insoluble polymer is produced by, for example, subjecting a monomer composition, containing a monomer (later described), to polymerization in an aqueous solvent so as to obtain a polymer in the form of particles.

Examples of the monomer used to produce the water-insoluble polymer encompass styrene, vinyl ketone, acrylonitrile, methyl methacrylate, ethyl methacrylate, glycidyl methacrylate, glycidyl acrylate, methyl acrylate, ethyl acrylate, and butyl acrylate.

The polymer in the form of particles also contains, in addition to a homopolymer of the monomer, a copolymer of two or more kinds of monomers. Examples of the polymer encompass: fluorine-containing resins such as polytetrafluoroethylene, a tetrafluoroethylene-hexafluoropropylene copolymer, an ethylene-tetrafluoroethylene copolymer, and polyvinylidene fluoride; melamine resin; urea resin; polyethylene; polypropylene; polyacrylic acid; and polymethacrylic acid.

The aqueous solvent is not limited to any particular one, provided that the aqueous solvent contains water as a main component and allows the particles of the water-insoluble polymer to be dispersed therein. The aqueous solvent can contain, in any amount, an organic solvent, such as methanol, ethanol, isopropyl alcohol, acetone, tetrahydrofuran, acetonitrile, or N-methylpyrrolidone, which can be mixed with the water in any ratio. Furthermore, the aqueous solvent can contain a surfactant such as sodium dodecylbenzenesulfonate, a dispersing agent such as a sodium salt of polyacrylic acid or a sodium salt of carboxymethylcellulose, and/or the like. In a case where an additive(s) such as the organic solvent and/or the surfactant is/are used, merely one kind of additive can be used or two or more kinds of additives can be alternatively used in combination. A weight ratio of the organic solvent relative to the water is 0.1% by weight to 99% by weight, preferably 0.5% by weight to 80% by weight, more preferably 1% by weight to 50% by weight.

Note that the porous layer in accordance with an embodiment of the present invention can contain merely one kind of resin or can alternatively contain a mixture of two or more kinds of resins.

Concrete examples of the aromatic polyamides encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Out of those aromatic polyamides, poly(paraphenylene terephthalamide) is more preferable.

Out of the above resins, a polyolefin, a fluorine-containing resin, an aromatic polyamide, a water-soluble polymer, or the water-insoluble polymer in the form of particles dispersed in the aqueous solvent is more preferable. Out of those resins, in a case where the porous layer is arranged so as to face the cathode, a fluorine-containing resin or a fluorine-containing rubber is still more preferable, and a homopolymer of vinylidene fluoride (that is, polyvinylidene fluoride) or a copolymer of vinylidene fluoride and at least one monomer or the like selected from the group consisting of hexafluoropropylene, tetrafluoroethylene, trifluoroethylene, trichloroethylene, and vinyl fluoride (that is, a vinylidene fluoride-hexafluoropropylene copolymer or the like) is particularly preferable, because such a resin make it easy to maintain various properties, such as a rate characteristic and a resistance characteristic (solution resistance), of the nonaqueous electrolyte secondary battery even in a case where the nonaqueous electrolyte secondary battery suffers acidic deterioration during operation of the nonaqueous electrolyte secondary battery. Further, a water-soluble polymer or the water-insoluble polymer in the form of particles dispersed in the aqueous solvent is more preferable in view of a process and an environmental load, because water can be used as a solvent to form the porous layer. The water-soluble polymer is still more preferably cellulose ether or sodium alginate, and particularly preferably cellulose ether.

Concrete examples of the cellulose ether encompass carboxymethyl cellulose (CMC), hydroxyethyl cellulose (HEC), carboxyethyl cellulose, methyl cellulose, ethyl cellulose, cyanoethyl cellulose, and oxyethyl cellulose. The cellulose ether is more preferably CMC or HEC, and particularly preferably CMC, because CMC and HEC less degrade in use over a long term and are excellent in chemical stability.

In view of adhesion of an inorganic filler, the water-insoluble polymer in the form of particles dispersed in the aqueous solvent is preferably a homopolymer of an acrylate monomer, such as methyl methacrylate, ethyl methacrylate, glycidyl methacrylate, glycidyl acrylate, methyl acrylate, ethyl acrylate, or butyl acrylate, or is alternatively preferably a copolymer of two or more monomers.

In this specification, the fine particles are organic fine particles or inorganic fine particles which organic fine particles and inorganic fine particles are generally called fillers. Therefore, the resin is to serve as a binder resin for bonding the fine particles together and bonding the fine particles to the porous film. The fine particles are preferably electrically insulating fine particles.

Concrete examples of the organic fine particles contained in the porous layer in accordance with an embodiment of the present invention encompass: homopolymers of monomers such as styrene, vinyl ketone, acrylonitrile, methyl methacrylate, ethyl methacrylate, glycidyl methacrylate, glycidyl acrylate, and methyl acrylate; copolymers of two or more kinds of monomers such as styrene, vinyl ketone, acrylonitrile, methyl methacrylate, ethyl methacrylate, glycidyl methacrylate, glycidyl acrylate, and methyl acrylate; fluorine-containing resins such as polytetrafluoroethylene, a tetrafluoroethylene-hexafluoropropylene copolymer, an ethylene-tetrafluoroethylene copolymer, and polyvinylidene fluoride; melamine resin; urea resin; polyethylene; polypropylene; polyacrylic acid; and polymethacrylic acid. These organic fine particles are electrically insulating fine particles.

Concrete examples of the inorganic fine particles contained in the porous layer in accordance with an embodiment of the present invention encompass fillers each made of an inorganic matter such as calcium carbonate, talc, clay, kaolin, silica, hydrotalcite, diatomite, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, or glass. These inorganic fine particles are electrically insulating fine particles. Merely one kind of filler can be used solely. Alternatively, two or more kinds of fillers can be used in combination.

Out of the above fillers, a filler made of an inorganic matter is suitable as the filler. The filler is more preferably a filler made of an inorganic oxide such as silica, calcium oxide, magnesium oxide, titanium oxide, alumina, mica, zeolite, aluminum hydroxide, or boehmite, still more preferably at least one kind of filler selected from the group consisting of silica, magnesium oxide, titanium oxide, aluminum hydroxide, boehmite, and alumina, and particularly preferably alumina. There are various crystal forms of alumina, such as α-alumina, β-alumina, γ-alumina, and θ-alumina. It is possible to suitably use alumina of any form. Out of the various forms of alumina, α-alumina is the most preferable because α-alumina has particularly high thermal stability and particularly high chemical stability.

The filler is constituted by particles which vary in shape depending on a method of producing a raw material, i.e., an organic substance or an inorganic substance, a dispersion condition of the filler when a coating liquid for forming the porous layer is prepared, and the like. Each of the particles of the filler can have any shape such as a spherical shape, an oval shape, a rectangular shape, or a gourd-like shape or can alternatively have an indefinite shape, that is, no specific shape.

In a case where the porous layer contains the filler, the porous layer contains the filler in an amount of preferably 1% by volume to 99% by volume, more preferably 5% by volume to 95% by volume, relative to the porous layer. In a case where the amount of the filler falls within the above range, a void formed by contacts of the particles of the filler is less likely to be blocked by the resin and the like. This allows the porous layer to achieve sufficient ion permeability and an appropriate weight per unit area.

As the fine particles, two or more kinds of fine particles which kinds are different in particle diameter and/or in specific surface area can be used in combination.

The porous layer contains the fine particles in an amount of preferably 1% by volume to 99% by volume, more preferably 5% by volume to 95% by volume, relative to the porous layer. In a case where the amount of the fine particles falls within the above range, a void formed by contacts of the fine particles is less likely to be blocked by the resin and the like. This allows the porous layer to achieve sufficient ion permeability and an appropriate weight per unit area.

A film thickness of the porous layer in accordance with an embodiment of the present invention can be determined as appropriate in consideration of the film thickness of the laminated body which is the nonaqueous electrolyte secondary battery laminated separator. In a case where the laminated body is formed by providing the porous layer on one or each of the surfaces of the porous film serving as a base material, the film thickness of the porous layer is preferably 0.5 μm to 15 μm (per one surface), more preferably 2 μm to 10 μm (per one surface).

The film thickness of the porous layer is preferably not less than 1 μm because, in a case where the laminated body is used as the nonaqueous electrolyte secondary battery laminated separator, such a porous layer (i) makes it possible to sufficiently prevent an internal short circuit caused by breakage or the like of the nonaqueous electrolyte secondary battery and (ii) is capable of retaining a sufficiently large amount of an electrolyte. Meanwhile, the film thickness of the porous layer is preferably not more than 30 μm in total on both of the surfaces of the porous film because, in a case where the laminated body is used as the nonaqueous electrolyte secondary battery laminated separator, such a porous layer makes it possible to (i) reduce resistance, to permeation of lithium ions, of the entire nonaqueous electrolyte secondary battery laminated separator and prevent a deterioration in cathode which deterioration is caused in a case where charge-discharge cycles are repeated, thereby improving a rate characteristic and a cycle characteristic, and furthermore (ii) reduce a distance between the cathode and the anode, thereby reducing a size of the nonaqueous electrolyte secondary battery.

In the descriptions below relating to physical properties of the porous layer, in a case where the porous layer is provided on each of the surfaces of the porous film, at least physical properties of the porous layer which is provided on the surface of the porous film which surface faces the cathode in the nonaqueous electrolyte secondary battery are indicated.

A weight per unit area (per one surface) of the porous layer can be determined as appropriate in consideration of strength, a film thickness, mass, and handleability of the laminated body. In general, the weight per unit area of the porous layer is preferably 1 g/m² to 20 g/m², more preferably 2 g/m² to 10 g/m² so that, in a case where the laminated body is used as the nonaqueous electrolyte secondary battery laminated separator, the nonaqueous electrolyte secondary battery has a higher weight energy density and a higher volume energy density. In a case where (i) the weight per unit area of the porous layer is greater than the above range and (ii) the laminated body is used as the nonaqueous electrolyte secondary battery laminated separator, the nonaqueous electrolyte secondary battery becomes heavier.

A porosity of the porous layer is preferably 20% by volume to 90% by volume, more preferably 30% by volume to 80% by volume so that the porous layer can achieve sufficient ion permeability. A pore diameter of each of pores in the porous layer is preferably not more than 3 μm, more preferably not more than 1 μm, and still more preferably not more than 0.5 μm so that the porous layer and the nonaqueous electrolyte secondary battery laminated separator including the porous layer can achieve sufficient ion permeability.

[Laminated Body]

The laminated body which is the nonaqueous electrolyte secondary battery laminated separator in accordance with an embodiment of the present invention includes the porous film and the porous layer which is provided on one or each of the surfaces of the porous film.

The film thickness of the laminated body in accordance with an embodiment of the present invention is preferably 5.5 μm to 45 μm, more preferably 6 μm to 25 μm.

Air permeability of the laminated body in accordance with an embodiment of the present invention is, in terms of Gurley values, preferably 30 sec/100 mL to 1,000 sec/100 mL, more preferably 50 sec/100 mL to 800 sec/100 mL. In a case where the laminated body which has the above air permeability is used as the nonaqueous electrolyte secondary battery laminated separator, the nonaqueous electrolyte secondary battery laminated separator can achieve sufficient ion permeability. It is preferable that the air permeability be not more than 1,000 sec/100 mL because, in a case where the laminated body is used as the nonaqueous electrolyte secondary battery laminated separator, the nonaqueous electrolyte secondary battery laminated separator can achieve sufficient ion permeability and accordingly makes it possible to sufficiently increase a battery characteristic of the nonaqueous electrolyte secondary battery. Meanwhile, it is preferable that the air permeability be not less than 30 sec/100 mL because it is possible to increase strength of the laminated body and accordingly possible to maintain shape stability of the nonaqueous electrolyte secondary battery laminated separator particularly at a high temperature.

Note that the laminated body in accordance with an embodiment of the present invention can include, as necessary, a publicly known porous film, such as a heat-resistant layer, an adhesive layer, or a protective layer, in addition to the porous film and the porous layer, provided that the publicly known porous film does not impair the purpose of the present invention.

The laminated body in accordance with an embodiment of the present invention includes, as a base material, the porous film which contains the phosphoric esters in an amount of not less than 5 ppm and not more than 700 ppm in terms of a mass ratio relative to total mass of the porous film. Therefore, use of the laminated body as the nonaqueous electrolyte secondary battery laminated separator makes it possible to obtain the nonaqueous electrolyte secondary battery which is excellent in rate characteristic maintaining property after charge-discharge cycles.

[Method of Producing Porous Layer and Method of Producing Laminated Body]

The porous layer in accordance with an embodiment of the present invention and the laminated body in accordance with an embodiment of the present invention can be each produced by, for example, (i) applying a coating liquid (later described) to the surface of the porous film and (ii) drying the coating liquid so that a solid content of the coating liquid is deposited as the porous layer.

The coating liquid used to produce the porous layer in accordance with an embodiment of the present invention can be typically prepared by (i) dissolving, in a solvent, the resin to be contained in the porous layer in accordance with an embodiment of the present invention and (ii) dispersing the fine particles to be contained in the porous layer in accordance with an embodiment of the present invention.

The solvent (dispersion medium) is not limited to any particular one, provided that the solvent (i) does not adversely affect the porous film, (ii) dissolves the resin uniformly and stably, and (iii) causes the fine particles to be dispersed therein uniformly and stably. Concrete examples of the solvent (dispersion medium) encompass water; lower alcohols such as methyl alcohol, ethyl alcohol, n-propyl alcohol, isopropyl alcohol, and t-butyl alcohol; acetone; toluene; xylene; hexane; N-methylpyrrolidone; N,N-dimethylacetamide; and N,N-dimethylformamide. Each of those solvents (dispersion media) can be used solely. Alternatively, two or more of those solvents (dispersion media) can be used in combination.

The coating liquid can be prepared by any method, provided that conditions (such as a resin solid content (resin concentration) and a fine particle amount) necessary to obtain an intended porous layer are satisfied. Concrete examples of a method of preparing the coating liquid encompass a mechanical stirring method, an ultrasonic dispersion method, a high-pressure dispersion method, and a medium dispersion method. Further, the fine particles can be dispersed in the solvent (dispersion medium) with use of a conventionally publicly known dispersing device such as a three-one motor, a homogenizer, a medium type dispersing device, or a pressure type dispersing device. Moreover, an emulsified liquid of the resin or a liquid in which the resin is dissolved or swollen can be supplied to a wet grinding device when wet grinding is carried out so as to obtain fine particles having an intended average particle diameter, and it is thus possible to prepare the coating liquid concurrently with the wet grinding of the fine particles. That is, the wet grinding of the fine particles and preparation of the coating liquid can be carried out by a single process. The coating liquid can contain, as a component other than the resin and the fine particles, an additive such as a dispersing agent, a plasticizer, a surfactant, or a pH adjuster, provided that the additive does not impair the purpose of the present invention. Note that the additive can be added in any amount, provided that the amount does not impair the purpose of the present invention.

A method of applying the coating liquid to the porous film is not limited to any particular one. That is, a method of forming the porous layer on the surface of the porous film which has been subjected to hydrophilizing treatment as necessary is not limited to any particular one. In a case where the porous layer is provided on each of the surfaces of the porous film, it is possible to employ (i) a sequential providing method in which a porous layer is formed on one of the surfaces of the porous film and then another porous layer is formed on the other one of the surfaces of the porous film or (ii) a simultaneous providing method in which porous layers are simultaneously formed on the respective surfaces of the porous film. Examples of the method of forming the porous layer, that is, a method of producing the laminated body encompass: a method in which the coating liquid is applied directly to the surface of the porous film and then the solvent (dispersion medium) is removed; a method in which the coating liquid is applied to an appropriate support, the solvent (dispersion medium) is removed so that the porous layer is formed, the porous layer and the porous film are bonded together by pressure, and then the support is peeled off; a method in which the coating liquid is applied to an appropriate support, the porous film is bonded to a resultant coated surface by pressure, the support is peeled off, and then the solvent (dispersion medium) is removed; a method in which dip coating is carried out by soaking the porous film in the coating liquid, and then the solvent (dispersion medium) is removed; and the like. A thickness of the porous layer can be controlled by adjusting a thickness of a coating film which is in a wet state (Wet) after coating, a mass ratio between the resin and the fine particles, a solid content concentration (i.e., a sum of a resin concentration and a fine particle concentration) of the coating liquid, and the like. Note that the support can be, for example, a resin film, a metal belt, a drum, or the like.

The method of applying the coating liquid to the porous film or the support is not limited to any particular one, provided that the method allows a necessary weight per unit area and a necessary coating area to be realized. As the method of applying the coating liquid to the porous film or the support, a conventionally publicly known method can be employed. Concrete examples of the method encompass a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, and a spray coating method.

The solvent (dispersion medium) is generally removed by drying the coating liquid. Examples of a method of drying the coating liquid encompass natural drying, air-blowing drying, heat drying, and drying under reduced pressure. Note, however, that any method can be employed, provided that the solvent (dispersion medium) can be sufficiently removed. Note also that the coating liquid can be dried after the solvent (dispersion medium) contained in the coating liquid is replaced with another solvent. Examples of a method of replacing the solvent (dispersion medium) with another solvent and then removing the another solvent encompass a method in which (i) the porous film or the support to which the coating liquid has been applied so that a coating film is formed on the porous film or the support is soaked in another solvent (hereinafter, referred to as a “solvent X”) so that the solvent (dispersion medium) contained in the coating film formed on the porous film or the support is replaced with the solvent X and then (ii) the solvent X is evaporated. Note that the solvent X is a solvent which is dissolved in the solvent (dispersion medium) contained in the coating liquid and which does not dissolve the resin contained in the coating liquid. According to such a method, it is possible to efficiently remove the solvent (dispersion medium) from the coating liquid. Note that, in a case where the solvent (dispersion medium) or the solvent X is removed, by heating, from the coating film of the coating liquid formed on the porous film or the support, the heating is preferably carried out at a temperature at which the air permeability of the porous film will not be decreased, specifically, at 10° C. to 120° C., more preferably 20° C. to 80° C., so as to avoid a decrease in air permeability caused by shrinkage of the pores in the porous film.

The above drying can be carried out with use of a general dryer.

### Embodiment 3: Nonaqueous Electrolyte Secondary Battery Member, Embodiment 4: Nonaqueous Electrolyte Secondary Battery

The nonaqueous electrolyte secondary battery member in accordance with Embodiment 3 of the present invention includes the cathode, the nonaqueous electrolyte secondary battery separator in accordance with Embodiment 1 of the present invention or the nonaqueous electrolyte secondary battery laminated separator in accordance with Embodiment 2 of the present invention, and the anode which are arranged in this order. The nonaqueous electrolyte secondary battery in accordance with Embodiment 4 of the present invention includes the nonaqueous electrolyte secondary battery separator in accordance with Embodiment 1 of the present invention or the nonaqueous electrolyte secondary battery laminated separator in accordance with Embodiment 2 of the present invention, and preferably includes the nonaqueous electrolyte secondary battery member in accordance with Embodiment 3 of the present invention. Note that the nonaqueous electrolyte secondary battery in accordance with Embodiment 4 of the present invention further includes a nonaqueous electrolyte.

[Nonaqueous Electrolyte]

The nonaqueous electrolyte in accordance with an embodiment of the present invention is a nonaqueous electrolyte that is typically used in a nonaqueous electrolyte secondary battery, and is not limited to any particular one. For example, it is possible to use a nonaqueous electrolyte obtained by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. Each of those lithium salts can be used solely. Alternatively, two or more kinds of those lithium salts can be used in combination. The lithium salt is more preferably at least one kind of fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃, out of the above lithium salts.

Concrete examples of the organic solvent which is a component of the nonaqueous electrolyte in accordance with an embodiment of the present invention encompass: carbonates such as ethylene carbonate, propylene carbonate, dimethyl carbonate, diethyl carbonate, ethyl methyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propanesultone; and fluorine-containing organic solvents each obtained by introducing a fluorine group into any of the above organic solvents. Each of those organic solvents can be used solely. Alternatively, two or more kinds of those organic solvents can be used in combination. Out of the above organic solvents, the organic solvent is more preferably any of the carbonates, and is still more preferably a mixed solvent of a cyclic carbonate and a non-cyclic carbonate or a mixed solvent of a cyclic carbonate and an ether. The mixed solvent of a cyclic carbonate and a non-cyclic carbonate is further preferably a mixed solvent containing ethylene carbonate, dimethyl carbonate, and ethyl methyl carbonate, because the mixed solvent containing ethylene carbonate, dimethyl carbonate, and ethyl methyl carbonate has a wide operating temperature range and exhibits a persistent property even in a case where a graphite material such as natural graphite or artificial graphite is used as an anode active material.

[Cathode]

As the cathode, typically used is a sheet-form cathode in which a cathode mix containing a cathode active material, an electrically conductive material, and a binding agent is supported on a cathode current collector.

The cathode active material is, for example, a material which can be doped with or dedoped of lithium ions. Concrete examples of such a material encompass lithium composite oxides each containing at least one kind of transition metal such as V, Mn, Fe, Co, or Ni. Out of the lithium composite oxides, more preferable is (i) a lithium composite oxide, such as lithium nickel oxide or lithium cobalt oxide, which has an α-NaFeO₂ structure or (ii) a lithium composite oxide, such as lithium manganese spinel, which has a spinel structure, because these lithium composite oxides each have a high average discharge potential. Such a lithium composite oxide can contain any of various metal elements, and is still more preferably a lithium-nickel composite oxide.

Further, it is still more preferable to use a lithium-nickel composite oxide containing at least one kind of metal element, selected from the group consisting of Ti, Zr, Ce, Y, V, Cr, Mn, Fe, Co, Cu, Ag, Mg, Al, Ga, In and Sn, in an amount of 0.1 mol % to 20 mol % relative to a sum of the number of moles of the at least one kind of metal element and the number of moles of Ni in nickel-lithium oxide. This is because such a lithium-nickel composite oxide is excellent in cycle characteristic in a high-capacity use. Out of these, it is particularly preferable to employ an active substance which contains Al or Mn and which has an Ni-ratio of not less than 85%, more preferably not less than 90%, because a nonaqueous electrolyte secondary battery which includes the cathode containing the active substance is excellent in cycle characteristic in a high-capacity use.

Examples of the electrically conductive material encompass carbonaceous materials such as natural graphite, artificial graphite, cokes, carbon black, pyrolytic carbons, carbon fiber, and a fired product of an organic polymer compound. Each of those electrically conductive materials can be used solely. Alternatively, two or more kinds of those electrically conductive materials can be used in combination, that is, for example, a mixture of artificial graphite and carbon black can be used.

Examples of the binding agent encompass: thermoplastic resins such as polyvinylidene fluoride, a vinylidene fluoride copolymer, polytetrafluoroethylene, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene copolymer, a vinylidene fluoride-hexafluoropropylene-tetrafluoroethylene copolymer, thermoplastic polyimides, polyethylene, and polypropylene; acrylic resins; and styrene-butadiene rubbers. Note that the binding agent also has a function as a thickener.

Examples of a method of obtaining the cathode mix encompass: a method in which the cathode active material, the electrically conductive material, and the binding agent are pressed on the cathode current collector; and a method in which the cathode active material, the electrically conductive material, and the binding agent are formed into a paste with use of an appropriate organic solvent.

Examples of the cathode current collector encompass electric conductors such as Al, Ni, and stainless steel. Al is more preferable because Al can be easily formed into a thin film and is inexpensive.

Examples of a method of producing the sheet-form cathode, i.e., a method of causing the cathode current collector to support the cathode mix encompass: a method in which the cathode active material, the electrically conductive material, and the binding agent which constitute the cathode mix are pressure-molded on the cathode current collector; and a method in which (i) the cathode mix is obtained by forming the cathode active material, the electrically conductive material, and the binding agent into a paste with use of an appropriate organic solvent, (ii) the cathode current collector is coated with the cathode mix, and then (iii) a sheet-form cathode mix obtained by drying the cathode mix is pressed so as to be firmly fixed to the cathode current collector.

[Anode]

As the anode, typically used is a sheet-form anode in which an anode mix containing an anode active material is supported on an anode current collector. The sheet-form anode preferably contains the above-described electrically conductive material and the above-described binding agent.

The anode active material is, for example, (i) a material which can be doped with or dedoped of lithium ions, (ii) lithium metal, or (iii) a lithium alloy. Concrete examples of such a material encompass: carbonaceous materials such as natural graphite, artificial graphite, cokes, carbon black, pyrolytic carbons, carbon fiber, and a fired product of an organic polymer compound; chalcogen compounds, such as an oxide and a sulfide, each of which can be doped with or dedoped of lithium ions at an electric potential lower than that of the cathode; metals, such as aluminum (Al), lead (Pb), tin (Sn), bismuth (Bi), and silicon (Si), each of which is alloyed with an alkali metal; intermetallic compounds of a cubic system (AlSb, Mg₂Si, NiSi₂) in each of which an alkali metal can be inserted in voids in a lattice; and lithium nitrogen compounds (Li₃₋ₓMₓN (M: transition metal)). Out of the above anode active materials, more preferable is a carbonaceous material which contains a graphite material, such as natural graphite or artificial graphite, as a main component, because a great energy density can be obtained, due to superior potential flatness and low average discharge potential, in a case where the carbonaceous material is combined with the cathode. Alternatively, the anode active material can be a mixture of graphite and silicon. In such a case, it is preferable to employ an anode active material in which a ratio of Si to carbon (C) constituting graphite is not less than 5%, and it is more preferable to employ an anode active material in which the ratio of Si to carbon (C) constituting graphite is not less than 10%.

Examples of a method of obtaining the anode mix encompass: a method in which the anode active material is pressed on the anode current collector; and a method in which the anode active material is formed into a paste with use of an appropriate organic solvent.

Examples of the anode current collector encompass Cu, Ni, and stainless steel. In particular, Cu is more preferable because Cu hardly forms an alloy with lithium in a lithium-ion secondary battery and because Cu can be easily formed into a thin film.

Examples of a method of producing the sheet-form anode, i.e., a method of causing the anode current collector to support the anode mix encompass: a method in which the anode active material which constitutes the anode mix is pressure-molded on the anode current collector; and a method in which (i) the anode mix is obtained by forming the anode active material into a paste with use of an appropriate organic solvent, (ii) the anode current collector is coated with the anode mix, and then (iii) a sheet-form anode mix obtained by drying the anode mix is pressed so as to be firmly fixed to the anode current collector. The paste preferably contains the electrically conductive material and the binding agent.

The nonaqueous electrolyte secondary battery member in accordance with an embodiment of the present invention can be produced, for example, by arranging the cathode, the porous film or the laminated body, and the anode in this order. The nonaqueous electrolyte secondary battery in accordance with an embodiment of the present invention can be produced, for example, by (i) forming the nonaqueous electrolyte secondary battery member by the above method, (ii) putting the nonaqueous electrolyte secondary battery member into a container that serves as a housing of the nonaqueous electrolyte secondary battery, (iii) filling the container with the nonaqueous electrolyte, and then (iv) sealing the container while reducing pressure. A shape of the nonaqueous electrolyte secondary battery is not limited to any particular one, and can be any of shapes such as a thin plate (paper) shape, a disc-like shape, a cylindrical shape, and a prismatic shape such as a rectangular parallelepiped. Note that a method of producing the nonaqueous electrolyte secondary battery member and a method of producing the nonaqueous electrolyte secondary battery are not limited to any particular ones, and conventionally publicly known production methods can be employed.

The nonaqueous electrolyte secondary battery member in accordance with an embodiment of the present invention includes, as the nonaqueous electrolyte secondary battery separator or as a base material of the nonaqueous electrolyte secondary battery laminated separator, the porous film which contains the phosphoric esters in an amount of not less than 5 ppm and not more than 700 ppm in terms of a mass ratio relative to total mass of the porous film. Such a nonaqueous electrolyte secondary battery member allows an improvement in rate characteristic maintaining property, after charge-discharge cycles, of the nonaqueous electrolyte secondary battery which includes the nonaqueous electrolyte secondary battery member.

The nonaqueous electrolyte secondary battery in accordance with an embodiment of the present invention includes, as the nonaqueous electrolyte secondary battery separator or as a base material of the nonaqueous electrolyte secondary battery laminated separator, the porous film which contains the phosphoric esters in an amount of not less than 5 ppm and not more than 700 ppm in terms of a mass ratio relative to total mass of the porous film. This allows an improvement in rate characteristic maintaining property, after charge-discharge cycles, of the nonaqueous electrolyte secondary battery.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### EXAMPLES

<Method of Measuring Various Physical Properties>

Various physical properties of a nonaqueous electrolyte secondary battery separator (porous film) in accordance with each of Examples 1 through 7 and Comparative Examples 1 and 2 below were measured by the following methods.

(1) Method of Measuring Amount of Phosphoric Esters

An amount of phosphoric esters: tris(2,4-di-tert-butylphenyl)phosphate contained in the nonaqueous electrolyte secondary battery separator obtained in each of Examples 1 through 7 and Comparative Examples 1 and 2 below was measured by the following method.

A sample for measurement was prepared by cutting a piece, having a weight of approximately 1 g to 3 g, out of the nonaqueous electrolyte secondary battery separator. The sample thus prepared was subjected to Soxhlet extraction for 8 hours while chloroform was being heated and refluxed, and, as a result, an extraction liquid was obtained. The extraction liquid thus obtained was subjected to liquid chromatography so that the phosphoric esters contained in the extraction liquid were separated. By quantifying the amount of the phosphoric esters, the amount of the phosphoric esters contained in a porous film was measured.

(2) Measurement of Rate Characteristic after Charge-Discharge Cycles

A nonaqueous electrolyte secondary battery assembled as described later was subjected to 4 cycles of initial charge and discharge. Each of the 4 cycles of initial charge and discharge was carried out at 25° C., at a voltage of 4.1 V to 2.7 V, and under an electric current of 0.2 C. Note here that 1 C is defined as a value of an electric current under which a rated capacity based on a discharge capacity at 1 hour rate is discharged for 1 hour, and the same applies to the following description.

The nonaqueous electrolyte secondary battery which had been subjected to the 4 cycles of initial charge and discharge was subjected to 100 cycles of charge and discharge. Each of the 100 cycles of charge and discharge was carried out at 55° C., at a voltage of 4.3 V to 2.7 V, and under a charge current of 1 C and a discharge current of 10 C each of which charge current and discharge current was a constant current.

The nonaqueous electrolyte secondary battery which had been subjected to the 100 cycles of charge and discharge was subjected to 3 cycles of charge and discharge. Each of the 3 cycles of charge and discharge was carried out at 55° C. and under a charge current of 1 C and a discharge current of 0.2 C each of which charge current and discharge current was a constant current. The nonaqueous electrolyte secondary battery was further subjected to 3 cycles of charge and discharge. Each of the 3 cycles of charge and discharge was carried out at 55° C. and under a charge current of 1 C and a discharge current of 20 C each of which charge current and discharge current was a constant current. A ratio between (i) a discharge capacity obtained in the third cycle in which the discharge current was set to 0.2 C and (ii) a discharge capacity obtained in the third cycle in which the discharge current was set to 20 C (20 C discharge capacity/0.2 C discharge capacity) was calculated as a rate characteristic of the nonaqueous electrolyte secondary battery which had been subjected to 100 cycles of charge and discharge (rate characteristic after 100 cycles).

### Example 1

To acetone serving as a solvent, 1.15 mg of tris(2,4-di-tert-butylphenyl)phosphate (hereinafter, also referred to as a phosphoric ester A) represented by the following formula (A) was added as phosphoric esters so that an amount of a resultant solution became exactly 10 mL. By dissolving the tris(2,4-di-tert-butylphenyl)phosphate, a solution 1 containing the phosphoric esters (concentration of 115 ppm) was obtained. Subsequently, 100 μL of the solution 1 was mixed with acetone so that a total amount of a resultant solution became 10 mL. A solution 2 containing the phosphoric esters (concentration of 1.15 ppm) was thus obtained.

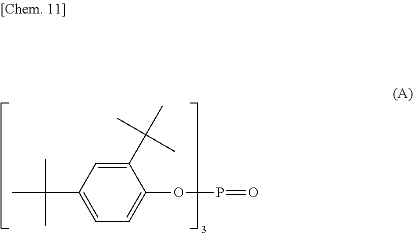

To a commercially available polyolefin porous film (olefin separator), 20 μL of the solution 2 containing the phosphoric esters (concentration of 1.15 ppm) was applied. Thereafter, the solvent was removed by evaporating the solvent. A nonaqueous electrolyte secondary battery separator (porous film) 1 was thus obtained. An amount of the phosphoric esters contained in the nonaqueous electrolyte secondary battery separator 1 was measured by the above-described method. The amount of the phosphoric esters was measured in terms of a mass ratio relative to total mass of the porous film. The amount of the phosphoric esters (phosphoric ester A) contained in the nonaqueous electrolyte secondary battery separator 1 was 5 μg/g.

<Production of Nonaqueous Electrolyte Secondary Battery>

Next, a nonaqueous electrolyte secondary battery was produced as below with use of the nonaqueous electrolyte secondary battery separator 1.

(Cathode)

A commercially available cathode was used which had been produced by applying LiNi_{0.5}Mn_{0.3}Co_{0.2}O₂/an electrically conductive material/PVDF (mass ratio of 92/5/3) to aluminum foil. The aluminum foil was cut out of the commercially available cathode so that (i) a portion of the aluminum foil on which portion a cathode active material layer was formed had a size of 45 mm×30 mm and (ii) a portion of the aluminum foil on which portion no cathode active material layer was formed and which portion had a width of 13 mm remained on an outer periphery of the portion on which the cathode active material layer was formed. A cathode thus obtained was used to produce the nonaqueous electrolyte secondary battery. The cathode active material layer had a thickness of 58 μm, a density of 2.50 g/cm³, and a cathode capacity of 174 mAh/g.

(Anode)

A commercially available anode was used which had been produced by applying graphite/a styrene-1,3-butadiene copolymer/sodium carboxymethylcellulose (mass ratio of 98/1/1) to copper foil. The copper foil was cut out of the commercially available anode so that (i) a portion of the copper foil on which portion an anode active material layer was formed had a size of 50 mm×35 mm and (ii) a portion of the copper foil on which portion no anode active material layer was formed and which portion had a width of 13 mm remained on an outer periphery of the portion on which the anode active material layer was formed. An anode thus obtained was used to produce the nonaqueous electrolyte secondary battery. The anode active material layer had a thickness of 49 μm, a density of 1.40 g/cm³, and an anode capacity of 372 mAh/g.

(Assembly)

The cathode, the nonaqueous electrolyte secondary battery separator, and the anode were provided (arranged) in this order in a laminate pouch so as to obtain a nonaqueous electrolyte secondary battery member 1. In so doing, the cathode and the anode were arranged so that a whole main surface of the cathode active material layer of the cathode was included in a range of a main surface (overlapped with the main surface) of the anode active material layer of the anode.

Subsequently, the nonaqueous electrolyte secondary battery member 1 was put in a bag made by providing an aluminum layer on a heat seal layer, and 0.25 mL of a nonaqueous electrolyte was poured into the bag. The nonaqueous electrolyte was an electrolyte which had a temperature of 25° C. and which had been obtained by dissolving LiPF₆, having a concentration of 1.0 mol/L, in a mixed solvent of ethyl methyl carbonate, diethyl carbonate, and ethylene carbonate in a volume ratio of 50:20:30. The bag was heat-sealed while pressure inside the bag was being reduced. As a result, a nonaqueous electrolyte secondary battery 1 was produced. The nonaqueous electrolyte secondary battery 1 had a design capacity of 20.5 mAh.

<Measurement of Rate Characteristic after Charge-Discharge Cycles>

A rate characteristic, after charge-discharge cycles, of the nonaqueous electrolyte secondary battery 1 was measured by the above-described method. Table 1 shows a result of such measurement.

### Example 2

First, 70% by mass of Ultra-high molecular weight polyethylene powder (GUR4032, manufactured by Ticona) and 30% by mass of polyethylene wax (FNP-0115, manufactured by Nippon Seiro Co., Ltd.) having a weight average molecular weight of 1,000 were prepared. To 100% by mass, in total, of the ultra-high molecular weight polyethylene powder and the polyethylene wax, 0.4% by mass of an antioxidant (Irg1010, manufactured by Ciba Specialty Chemicals Inc.), 0.1% by mass of an antioxidant (P168, manufactured by Ciba Specialty Chemicals Inc.), and 1.3% by mass of sodium stearate were added. Furthermore, calcium carbonate (manufactured by Maruo Calcium Co., Ltd.) having an average particle size of 0.1 μm was added so that the calcium carbonate accounted for 36% by volume of a total volume of all those compounds. The compounds were mixed in a state of powder with use of a Henschel mixer and melt-kneaded with use of a twin screw kneading extruder so as to obtain a polyolefin resin composition. The polyolefin resin composition was rolled with use of a pair of rollers, each having a surface temperature of 150° C., so as to prepare a sheet. This sheet was soaked in a hydrochloric acid aqueous solution (4 mol/L of hydrochloric acid, 0.5% by mass of nonionic surfactant) so that the calcium carbonate was removed from the sheet. The sheet was then stretched by 6.2 times at 100° C. to 105° C. and at a strain rate of 750% per minute, and a film having a film thickness of 16.3 μm was thus obtained. The film was then subjected to heat fixation at 115° C. so as to obtain a polyolefin porous film 1.

The polyolefin porous film 1 thus obtained was used to obtain a nonaqueous electrolyte secondary battery separator 2 containing, as phosphoric esters, a phosphoric ester A in an amount of 71 μg/g.

### Example 3

A polyolefin porous film 1 was obtained by a method similar to that in Example 2.

The polyolefin porous film 1 thus obtained was used to obtain a nonaqueous electrolyte secondary battery separator 3 containing, as phosphoric esters, a phosphoric ester A in an amount of 22 μg/g.

### Example 4

First, 70% by mass of Ultra-high molecular weight polyethylene powder (GUR4032, manufactured by Ticona) and 30% by mass of polyethylene wax (FNP-0115, manufactured by Nippon Seiro Co., Ltd.) having a weight average molecular weight of 1,000 were prepared. To 100% by mass, in total, of the ultra-high molecular weight polyethylene powder and the polyethylene wax, 0.4% by mass of an antioxidant (Irg1010, manufactured by Ciba Specialty Chemicals Inc.), 0.1% by mass of an antioxidant (P168, manufactured by Ciba Specialty Chemicals Inc.), and 1.3% by mass of sodium stearate were added. Furthermore, calcium carbonate (manufactured by Maruo Calcium Co., Ltd.) having an average particle size of 0.1 μm was added so that the calcium carbonate accounted for 36% by volume of a total volume of all those compounds. The compounds were mixed in a state of powder with use of a Henschel mixer and melt-kneaded with use of a twin screw kneading extruder so as to obtain a polyolefin resin composition. The polyolefin resin composition was rolled with use of a pair of rollers, each having a surface temperature of 150° C., so as to prepare a sheet. This sheet was soaked in a hydrochloric acid aqueous solution (4 mol/L of hydrochloric acid, 0.5% by mass of nonionic surfactant) so that the calcium carbonate was removed from the sheet. The sheet was then stretched by 6.2 times at 100° C. to 105° C. and at a strain rate of 1,250% per minute, and a film having a film thickness of 15.5 μm was thus obtained. The film was then subjected to heat fixation at 120° C. so as to obtain a polyolefin porous film 2.

The polyolefin porous film 2 thus obtained was used to obtain a nonaqueous electrolyte secondary battery separator 4 containing, as phosphoric esters, a phosphoric ester A in an amount of 100 μg/g.

### Example 5

A polyolefin porous film 2 was obtained by a method similar to that in Example 4.

The polyolefin porous film 2 thus obtained was used to obtain a nonaqueous electrolyte secondary battery separator 5 containing, as phosphoric esters, a phosphoric ester A in an amount of 19 μg/g.

### Example 6

A polyolefin porous film 1 was obtained by a method similar to that in Example 2.

The polyolefin porous film 1 thus obtained was used to obtain a nonaqueous electrolyte secondary battery separator 6 containing, as phosphoric esters, a phosphoric ester A in an amount of 270 μg/g.

### Example 7

A polyolefin porous film 2 was obtained by a method similar to that in Example 4.

The polyolefin porous film 2 thus obtained was used to obtain a nonaqueous electrolyte secondary battery separator 7 containing, as phosphoric esters, a phosphoric ester A in an amount of 370 μg/g.

### Comparative Example 1

A polyolefin porous film, identical to the commercially available polyolefin porous film used in Example 1, was used to obtain a comparison-use nonaqueous electrolyte secondary battery separator 1 containing, as phosphoric esters, a phosphoric ester A in an amount of 4 μg/g.

### Comparative Example 2

A polyolefin porous film 1 was obtained by a method similar to that in Example 2.

The polyolefin porous film 1 thus obtained was used to obtain a comparison-use nonaqueous electrolyte secondary battery separator 2 containing, as phosphoric esters, a phosphoric ester A in an amount of 1,400 μg/g.

<Production of Nonaqueous Electrolyte Secondary Battery, Measurement of Rate Characteristic after Charge-Discharge Cycles>

Comparison-use nonaqueous electrolyte secondary batteries were produced by methods similar to that in Example 1, except that the nonaqueous electrolyte secondary battery separators 2 through 7 and the comparison-use nonaqueous electrolyte secondary battery separators 1 and 2 were used instead of the nonaqueous electrolyte secondary battery separator 1. Then, a rate characteristic maintaining property (rate characteristic after 100 cycles) of each of such nonaqueous electrolyte secondary batteries was measured. Table 1 shows results of such measurement.

<Results>

TABLE 1

| | Contained amount of | Rate characteristic |
|---|---|---|
| | phosphoric esters (μg/g) | after 100 cycles (%) |
| Example 1 | 5 | 18 |
| Example 2 | 71 | 22 |
| Example 3 | 22 | 29 |
| Example 4 | 100 | 28 |
| Example 5 | 19 | 24 |
| Example 6 | 270 | 29 |
| Example 7 | 370 | 21 |
| Comparative | 4 | 2 |
| Example 1 | | |
| Comparative | 1,400 | 14 |
| Example 2 | | |

As is clear from Table 1, each of the nonaqueous electrolyte secondary batteries including the respective nonaqueous electrolyte secondary battery separators 1 through 7, which were obtained in Examples 1 through 7 and each of which contained the phosphoric esters in an amount of 5 μg/g (ppm) to 700 μg/g (ppm), had a higher rate characteristic after 100 cycles of charge and discharge and was therefore excellent in rate characteristic maintaining property, as compared with the nonaqueous electrolyte secondary batteries including the respective comparison-use nonaqueous electrolyte secondary battery separators 1 and 2, which were obtained in Comparative Examples 1 and 2 and each of which contained the phosphoric esters in an amount that did not fall with the above range.

### INDUSTRIAL APPLICABILITY

The nonaqueous electrolyte secondary battery separator in accordance with an aspect of the present invention and the nonaqueous electrolyte secondary battery laminated separator in accordance with an aspect of the present invention can be suitably used to produce a nonaqueous electrolyte secondary battery which is excellent in rate characteristic maintaining property.

1. A nonaqueous electrolyte secondary battery separator which is a porous film containing a polyolefin-based resin as a main component,
the porous film containing phosphoric esters in an amount of not less than 5 ppm and not more than 700 ppm in terms of a mass ratio relative to total mass of the porous film.

2. The nonaqueous electrolyte secondary battery separator as set forth in claim 1, wherein the porous film contains, as the phosphoric esters, at least one compound selected from the group consisting of: a compound represented by the following general formula (1); a polymer in which two or more compounds each represented by the general formula (1) are bonded via a single bond(s) or a linking group(s); and a polymer in which one or more compounds, each represented by the general formula (1), and one or more compounds, each represented by a general formula (1′), are bonded via a single bond(s) or a linking group(s),
P(═O)(R¹)(R²)(R³) (1)
where: R¹, R², and R³ each independently represent —OR⁴ or —R⁵; R⁴ and R⁵ each represent a hydrocarbon group and may be each bonded, via a single bond or a linking group, to R⁴ or R⁵ contained in another group in an identical molecule, R⁴ or R⁵ contained in another compound represented by the general formula (1), or R^{4′} or R^{5′} contained in a compound represented by the general formula (1′); and the linking group is a bivalent or higher-valent atom or a bivalent or higher-valent group,
P(R^{1′})(R^{2′})(R^{3′}) (1′)
where: R^{1′}, R^{2′}, and R^{3′} each independently represent —OR^{4′} or —R^{5′}; R^{4′} and R^{5′} each represent a hydrocarbon group and may be each bonded, via a single bond or a linking group, to R^{4′} or R^{5′} contained in another group in an identical molecule, R^{4′} or R^{5′} contained in another compound represented by the general formula (1′), or R⁴ or R⁵ contained in a compound represented by the general formula (1); and the linking group is a bivalent or higher-valent atom or a bivalent or higher-valent group.

3. The nonaqueous electrolyte secondary battery separator as set forth in claim 1, wherein the porous film contains, as the phosphoric esters, at least one compound selected from the group consisting of compounds represented by the following general formulae (2) through (6), 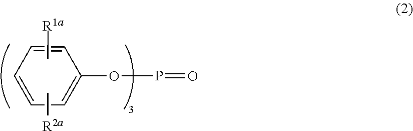
where R^{1a} and R^{2a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group, 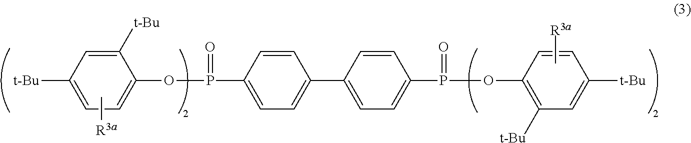
where R^{3a} represents a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group, 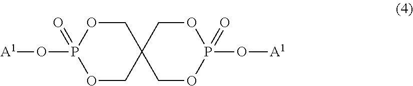
where A¹ represents an alkyl group having 1 to 18 carbon atom(s), a phenyl group which may be substituted with an alkyl group having 1 to 9 carbon atom(s), a phenyl group which may be substituted with a cycloalkyl group having 5 to 8 carbon atoms, a phenyl group which may be substituted with an alkylcycloalkyl group having 6 to 12 carbon atoms, or a phenyl group which may be substituted with an aralkyl group having 7 to 12 carbon atoms, 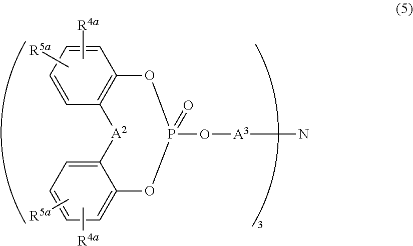
where: R^{4a} and R^{5a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group; A² represents a single bond, a sulfur atom, or an alkylidene group having 1 to 8 carbon atom(s); and A³ represents an alkylene group having 2 to 8 carbon atoms, 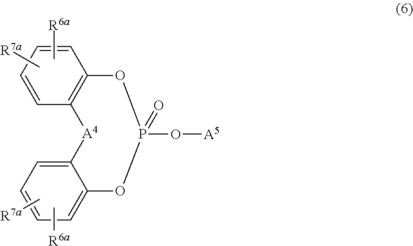
where: R^{6a} and R^{7a} each independently represent a hydrogen atom, an alkyl group having 1 to 9 carbon atom(s), a cycloalkyl group having 5 to 8 carbon atoms, an alkylcycloalkyl group having 6 to 12 carbon atoms, an aralkyl group having 7 to 12 carbon atoms, or a phenyl group; A⁴ represents a single bond, a sulfur atom, or an alkylidene group having 1 to 8 carbon atom(s); and A⁵ represents an alkyl group having 1 to 8 carbon atom(s), a phenyl group which may be substituted with an alkyl group having 1 to 9 carbon atom(s), a phenyl group which may be substituted with a cycloalkyl group having 5 to 8 carbon atoms, a phenyl group which may be substituted with an alkylcycloalkyl group having 6 to 12 carbon atoms, or a phenyl group which may be substituted with an aralkyl group having 7 to 12 carbon atoms.

4. The nonaqueous electrolyte secondary battery separator as set forth in claim 3, wherein the porous film contains, as the phosphoric esters, a compound represented by the general formula (2) or a compound represented by the general formula (5).

5. A nonaqueous electrolyte secondary battery laminated separator comprising:
a nonaqueous electrolyte secondary battery separator recited in claim 1; and
a porous layer.

6. A nonaqueous electrolyte secondary battery member comprising:
a cathode;
a nonaqueous electrolyte secondary battery separator recited in claim 1; and
an anode,
the cathode, the nonaqueous electrolyte secondary battery separator, and the anode being arranged in this order.

7. A nonaqueous electrolyte secondary battery member comprising:
a cathode;
a nonaqueous electrolyte secondary battery laminated separator recited in claim 5; and
an anode,
the cathode, the nonaqueous electrolyte secondary battery laminated separator, and the anode being arranged in this order.

8. A nonaqueous electrolyte secondary battery comprising a nonaqueous electrolyte secondary battery separator recited in claim 1.

9. A nonaqueous electrolyte secondary battery comprising a nonaqueous electrolyte secondary battery laminated separator recited in claim 5.
